(19) United States
(12) Patent Application Publication
(10) Pub. No.: US 2026/0157538 A1
(43) Pub. Date: Jun. 11, 2026

(54) TEMPERATURE-HUMIDITY MEASUREMENT INSTRUMENT

(71) Applicant: PARAMOUNT BED CO., LTD., Tokyo (JP)

(72) Inventors: Makoto TANAKA, Tokyo (JP); Masakazu HARADA, Tokyo (JP); Tsuyoshi KUMAMOTO, Tokyo (JP); Tomomi HAGIWARA, Tokyo (JP)

(73) Assignee: PARAMOUNT BED CO., LTD., Tokyo (JP)

(21) Appl. No.: 19/410,286

(22) Filed: Dec. 5, 2025

(30) Foreign Application Priority Data
Dec. 5, 2024 (JP) 2024-212489

(51) Int. Cl. A47C 31/12; A61G 7/057; G01K 1/02; G01K 13/024

(52) U.S. Cl. CPC A47C 31/123; A61G 7/05784; G01K 1/026; G01K 13/024; A61G 2203/30; A61G 2203/46

(57) ABSTRACT

A temperature-humidity measurement instrument includes a collecting section, a first flow path, a first temperature-humidity sensor, a second flow path, and a first air blowing apparatus. The collecting section is configured to collect air between a mattress and a person lying on the mattress. The first flow path is connected to the collecting section. The first temperature-humidity sensor is connected to the first flow path. The first temperature-humidity sensor is configured to measure a temperature and a humidity of the air collected in the collecting section. The second flow path is connected to the first temperature-humidity sensor. The first air blowing apparatus is configured to send the air measured by the first temperature-humidity sensor to the collecting section.

### CROSS-REFERENCE TO RELATED APPLICATIONS

This application is based upon and claims the benefit of priority from Japanese Patent Application No.2024-212489, filed on Dec. 5, 2024; the entire contents of which are incorporated herein by reference.

### FIELD

Embodiments of the present disclosure relate to a temperature-humidity measurement instrument.

### BACKGROUND

There are temperature-humidity measurement instruments that measure the temperature and the humidity between a mattress and a user.

### BRIEF DESCRIPTION OF THE DRAWINGS

FIG. 1 is a schematic view of a temperature-humidity measurement instrument according to the embodiment.

FIG. 2 is a schematic view of a temperature-humidity measurement instrument according to a first modification example of the embodiment.

FIG. 3 is a schematic view of a temperature-humidity measurement instrument according to a second modification example of the embodiment.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is a temperature-humidity measurement instrument including a collecting section, a first flow path, a first temperature-humidity sensor, a second flow path, and a first air blowing apparatus. The collecting section is configured to collect air between a mattress and a person lying on the mattress. The first flow path is connected to the collecting section. The first temperature-humidity sensor is connected to the first flow path. The first temperature-humidity sensor is configured to measure a temperature and a humidity of the air collected in the collecting section. The second flow path is connected to the first temperature-humidity sensor. The first air blowing apparatus is preferably provided between the first temperature-humidity sensor and the second flow path. The first air blowing apparatus is configured to send the air measured by the first temperature-humidity sensor to the collecting section.

A temperature-humidity measurement instrument according to an embodiment will be described. The temperature-humidity measurement instruments according to the embodiment are used by being attached to medical and care beds, for example. A mattress is provided to the bed, and a user lies on the mattress. The temperature-humidity measurement instrument according to the embodiment is also used in, in addition to a medical institution such as a hospital, a care facility or a home of the user. The user of the mattress is, for example, a patient or a care recipient. Hereinafter, an example of the temperature-humidity measurement instrument according to the embodiment will be described using the drawings.

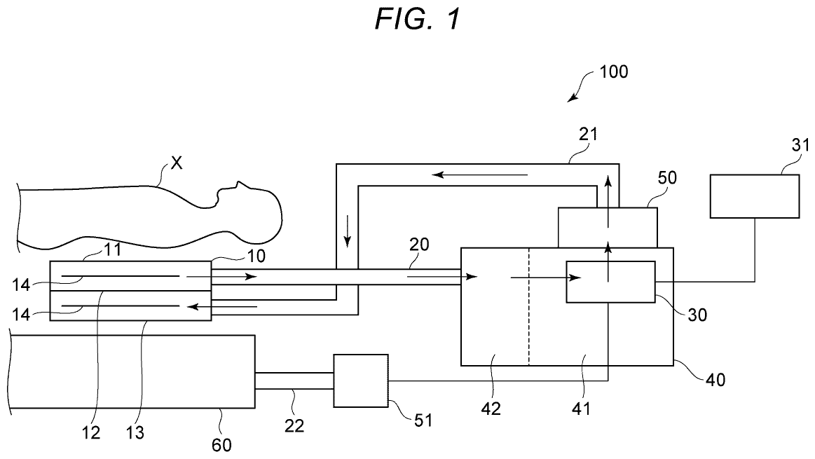

FIG. 1 is a schematic view of a temperature-humidity measurement instrument 100 according to the embodiment.

The temperature-humidity measurement instrument 100 according to the embodiment includes, as illustrated in FIG. 1, a collecting section 10, a first flow path 20, a first temperature-humidity sensor 30, a second flow path 21, and a first air blowing apparatus 50.

The collecting section 10 collects gas (air) between a mattress 60 and a person X (user) lying on the mattress 60. The collecting section 10 is provided between the mattress 60 and the person X (user) lying on the mattress 60.

The collecting section 10 includes, at least in part, a flexible substance. The collecting section 10 is preferably partially composed of a low friction material or a material having air permeability, for example, and more preferably includes a low friction material having air permeability. The material having air permeability may be a material itself having air permeability, or may be a material itself having no air permeability but physically having good air permeability by providing holes or the like in the material, for example. The air permeability of the collecting section 10 is preferably equal to or higher than 200 cc/(cm²·sec) by JIS K 6400-7:2012 B method, and the higher the permeability is, the more preferable it is. Examples of the low friction material can include silicone, a material containing silicone, a fluorinated polymer, a fluorinated copolymer, and a blend and a mixture thereof. The collecting section 10 may be coated with the low friction material. When cotton is assumed as a raw material for bedding and sheets, the static friction coefficient between the collecting section 10 and the cotton is preferably equal to or higher than 0.01 and equal to or lower than 0.40. The static friction coefficient between the collecting section 10 and resin is preferably lower than 0.40. The test method of a static friction coefficient is based on JIS K7125:1999 (ISO 8295:1995) Plastics-Film and sheeting-Determination of the coefficients of friction.

The first flow path 20 is connected to the collecting section 10. For example, the first flow path 20 is provided downstream from the collecting section 10. The first flow path 20 includes, at least in part, a flexible substance. The first flow path 20 is preferably partially composed of, for example, polyurethane, polyethylene, rubber, vinyl chloride, or silicone. The first flow path 20 may include a polyurethane foam provided to an outer peripheral section thereof for thermal insulation. The air collected from the collecting section 10 flows through an inside of the first flow path 20. The first flow path 20 is, for example, a tube or a pipe. In this manner, the first flow path 20 connects the collecting section 10 to a chamber 40, which is described later.

The first temperature-humidity sensor 30 is provided downstream from the first flow path 20. The first temperature-humidity sensor 30 measures a temperature and a humidity of the air collected in the collecting section 10 via the first flow path 20. The first temperature-humidity sensor 30 is not preferably provided between the mattress 60 and the person X lying on the mattress 60.

The second flow path 21 is preferably provided downstream from the first temperature-humidity sensor 30. The second flow path 21 includes, at least in part, a flexible substance. The second flow path 21 is preferably partially composed of, for example, polyurethane, polyethylene, rubber, vinyl chloride, or silicone. The second flow path 21 may be provided with a polyurethane foam on an outer peripheral section thereof for thermal insulation. The air measured by the first temperature-humidity sensor 30 circulates through an inside of the second flow path 21. The second flow path 21 is, for example, a tube or a pipe. In this manner, the second flow path 21 connects the first air blowing apparatus 50 to the collecting section 10.

The first air blowing apparatus 50 is provided between the first temperature-humidity sensor 30 and the second flow path 21. In other words, the first air blowing apparatus 50 is provided downstream from the first temperature-humidity sensor 30. The first air blowing apparatus 50 may include a heating element such as a coil that is used for sending the air. The heating element may have an influence on the temperature and the humidity of the air collected from the collecting section 10. The abovementioned configuration allows the temperature-humidity measurement instrument 100 to measure temperature and humidity with high reliability. The first air blowing apparatus 50 sends the air in the chamber 40 to the collecting section 10 via the second flow path 21. The first air blowing apparatus 50 may include a piezoelectric diaphragm pump, for example. The piezoelectric diaphragm pump containing no coil generates the extremely small amount of heat. The temperature-humidity measurement instrument 100 including the piezoelectric diaphragm pump can measure the more reliable temperature and humidity.

The gas (air) collected in the collecting section 10 reaches the first temperature-humidity sensor 30 via the first flow path 20. The first temperature-humidity sensor 30 measures a temperature and a humidity of the gas collected in the collecting section 10.

In this manner, the air collected from the collecting section 10 is returned again to the collecting section 10 by the first air blowing apparatus 50 via the first flow path 20, the chamber 40, the first air blowing apparatus 50, and the second flow path 21. The air circulates. The first temperature-humidity sensor 30 measures the circulating air. For example, in a case where the air does not circulate, the collecting section 10 also sucks the air from the outside of the flow path, and as a result, the measurement with high reliability is difficult. The temperature-humidity measurement instrument 100 according to the embodiment can measure a temperature and a humidity of the air between the mattress 60 and the person X with high reliability. The temperature-humidity measurement instrument 100 circulates the air the temperature and the humidity of which are not controlled.

As mentioned above, the first temperature-humidity sensor 30 is not provided between the mattress 60 and the person X lying on the mattress 60 to result in reduced burden to the user. With the embodiment, it is possible to measure a temperature and a humidity while reducing burden to the user with high reliability.

As mentioned above, the first flow path 20 and the second flow path 21 may include a flexible substance. The material to be used in the first flow path 20 and the second flow path 21 may have a durometer hardness of equal to or less than A75 and equal to or more than A5, for example. The hardness of the collecting section 10 may be the same as the hardness of the first flow path 20 and the second flow path 21. The smaller the sizes of the first flow path 20 and the second flow path 21 are, the more the burden of the user is reduced. The first flow path 20 and the second flow path 21 preferably each have a dimension diameter of equal to or less than 10 mm, and a thickness of equal to or less than 4 mm, for example.

The collecting section 10 includes, for example, a polyurethane film, a polyurethane film with a surface provided with a film such as nylon, a rubber sheet, a vinyl chloride sheet, or a polyethylene sheet. The thickness of the collecting section 10 is equal to or more than 1 mm and equal to or less than 5 mm. The collecting section 10 including a flexible substance and having the abovementioned thickness applies a small load, such as an increase in the body pressure, to the person X lying on the mattress 60. The collecting section 10 preferably has a size smaller than that of the user due to a purpose of collecting the gas (air) between the mattress 60 and the person X (user) lying on the mattress 60. The collecting section 10 preferably has a size equal to or less than 15 cm, and more preferably equal to or less than 10 cm. The smaller the size is, the more it is preferable, but the size is preferably equal to or more than 1 cm.

The temperature-humidity measurement instrument 100 may further include the chamber 40. The first temperature-humidity sensor 30 is provided in the chamber 40. The air sent to the first temperature-humidity sensor 30 is stored in the chamber 40. The temperature and the humidity are measured in the chamber 40. In this way, an measurement result with high reliability is easily obtained.

For example, the chamber 40 may include a first chamber 41 and a second chamber 42. In this case, the first temperature-humidity sensor 30 is provided in the first chamber 41. The second chamber 42 is provided between the collecting section 10 and the first chamber 41. The second chamber 42 is provided upstream from the first chamber 41. The air collected from the collecting section 10 passes through the second chamber 42 via the first flow path 20, and flows into the first chamber 41. The first temperature-humidity sensor 30 provided in the first chamber 41 measures a temperature and a humidity of the gas (air) collected in the collecting section 10. For example, the moisture when the collecting section 10 has sucked incontinence and condensation has occurred in the first flow path 20 can be removed in the second chamber 42, so that it is possible to prevent a failure of the temperature-humidity sensor from occurring.

The first temperature-humidity sensor 30 may be provided outside the mattress 60, for example. Accordingly, the first temperature-humidity sensor 30 is not provided between the mattress 60 and the person X. It is possible to measure a temperature and a humidity between the mattress 60 and the person X, without a load such as an increase in the body pressure at an area where the temperature-humidity sensor is installed. For example, it is possible to measure a temperature and a humidity between the mattress 60 and the person X, without measuring a temperature and a humidity at a position that is covered with a comforter when the comforter is put over.

The collecting section 10, the position of which can be moved, can measure a temperature and a humidity in areas around a seat and shoulders where bedsores are easily developed as appropriate. Therefore, it is effective to prevent bedsores. The temperature-humidity measurement instrument 100 including the collecting section 10 can be moved.

Conventionally, the temperature-humidity sensor is downsized, and includes an electronic instrument. The temperature-humidity sensor is provided between the mattress 60 and the person X, so that the static electricity due to the friction between the mattress 60 and the person X may cause electrostatic breakdown in the electronic instrument included in the temperature-humidity sensor. The temperature-humidity measurement instrument 100 according to the embodiment can prevent the electrostatic breakdown in the electronic instrument because the first temperature-humidity sensor 30 is provided outside the mattress 60.

The temperature-humidity measurement instrument 100 according to the embodiment may further include a second temperature-humidity sensor 31 and a second air blowing apparatus 51. The second temperature-humidity sensor 31 measures a temperature and a humidity of the indoor air.

The second air blowing apparatus 51 is connected to the mattress 60 via a third flow path 22. The second air blowing apparatus 51 may be controlled to send the indoor air to the mattress 60 based on the temperature and the humidity measured by the first temperature-humidity sensor 30 and measured by the second temperature-humidity sensor 31. The second air blowing apparatus 51 is connected to the first temperature-humidity sensor 30 and the second temperature-humidity sensor 31 via an electric communication line. For example, in a case where the indoor temperature and humidity measured by the second temperature-humidity sensor 31 are low, in order to prevent bedsores, the second air blowing apparatus 51 sends the indoor air to the mattress 60. On the other hand, in a case where the indoor temperature and humidity measured by the second temperature-humidity sensor 31 are high, in order to prevent bedsores, the second air blowing apparatus 51 does not send the indoor air to the mattress 60. The temperature-humidity measurement instrument 100 according to the embodiment is further provided with the second temperature-humidity sensor 31, the second air blowing apparatus 51 and a controller to control the second air blowing apparatus 51 to have a bedsore prevention effect.

The collecting section 10 includes an upper film 11, an intermediate film 12, and a lower film 13. The upper film 11 and the lower film 13 each include a material having air permeability. The intermediate film 12 includes a material having no air permeability. In the collecting section 10, the air in a space formed by the upper film 11 and the intermediate film 12 is sent to the first flow path 20, the first temperature-humidity sensor 30, the first air blowing apparatus 50, and the second flow path 21. The air is returned through the second flow path 21 into a space formed by the lower film 13 and the intermediate film 12. The collecting section 10 can be a bag-shaped air pack. The bagshaped air pack may include the upper film 11, the intermediate film 12, and the lower film 13. In this case, the collecting section 10 includes the upper film 11 and the lower film 13, which have air permeability, so that it is possible to prevent the collecting section 10 from being blocked between the outer side and the inner side. It is possible to measure the more reliable temperature and humidity. The collecting section 10 may have a bag shape in which a polyurethane film, a polyurethane film having a surface provided with a nylon cloth, a polyethylene film, a thermoplastic resin such as a vinyl chloride film, or a rubber sheet is welded or bonded. The collecting section 10 may include, between the upper film 11 and the intermediate film 12, a blockage prevention layer 14 that prevents blockage of the first flow path 20. The collecting section 10 may include, between the intermediate film 12 and the lower film 13, a blockage prevention layer 14 that prevents blockage of the second flow path 21. The blockage prevention layers 14 are provided along the upper film 11, the intermediate film 12, and the lower film 13. The blockage prevention layer 14 is sandwiched between the upper film 11 and the intermediate film 12, or between the intermediate film 12 and the lower film 13. The blockage prevention layer 14 may be an urethane foam having air permeability. The blockage prevention layer 14 may be a three-dimensional stereoscopic knitted structure having air permeability. The blockage prevention layer 14 provided between the upper film 11 and the intermediate film 12 can prevent suction blockage of the air from the first flow path 20. The blockage prevention layer 14 provided between the intermediate film 12 and the lower film 13 can prevent discharge blockage of the air from the second flow path 21.

Hereinafter, modification examples of the temperature-humidity measurement instrument according to the embodiment will be described.

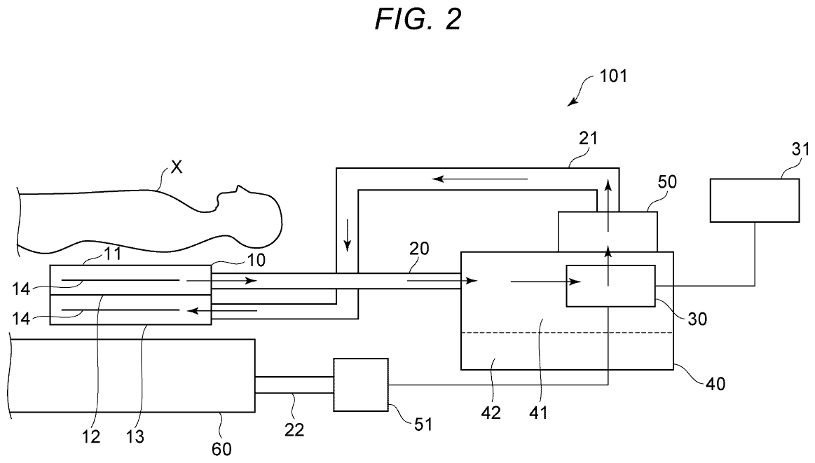

FIG. 2 is a schematic view of a temperature-humidity measurement instrument 101 according to a first modification example of the embodiment.

In the temperature-humidity measurement instrument 101 according to the first modification example of the embodiment, the second chamber 42 is provided to a lower part in the chamber 40.

In this way, in the second chamber 42, the moisture when the collecting section 10 has sucked incontinence and condensation has occurred in the first flow path 20 can be easily removed.

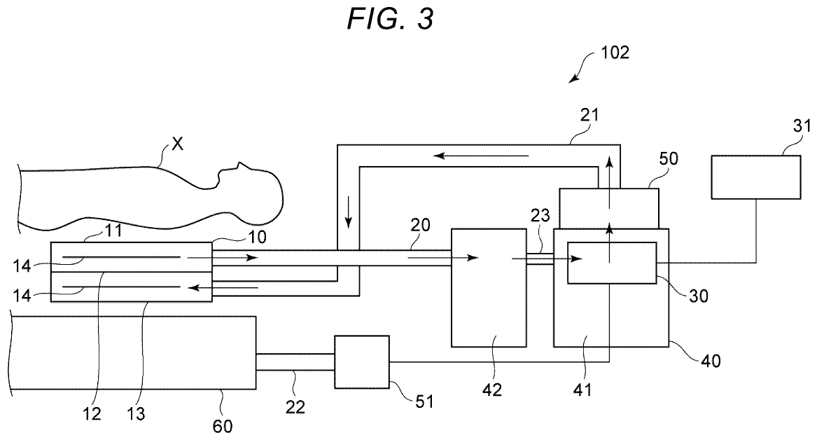

FIG. 3 is a schematic view of a temperature-humidity measurement instrument 102 according to a second modification example of the embodiment.

In the temperature-humidity measurement instrument 102 according to the second modification example of the embodiment, the second chamber 42 is provided upstream from the first temperature-humidity sensor 30. The second chamber 42 is connected to the first chamber 41 via a fourth flow path 23.

In this way, the second chamber 42 is provided in a different space from the first chamber 41, which can reduce an influence of the moisture in a case where the collecting section 10 has sucked incontinence and condensation has occurred in the first flow path 20 to be exerted on the first temperature-humidity sensor 30, and obtain the more reliable temperature and humidity even in the abovementioned case.

The temperature-humidity measurement instrument 102 according to the embodiment is preferably used for preventing bedsores, and is preferably used in a bed that is used as a measure against microclimate which is said to be one of causes of bedsores.

The aforementioned embodiment and modification examples are examples embodying the present disclosure, and the present disclosure is not limited to these embodiment and modification examples. For example, in each of the aforementioned embodiment and modification examples, the present disclosure also includes additions, deletions, or modifications of some elements or steps. In addition, the aforementioned embodiment and modification examples may be implemented in combination.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A temperature-humidity measurement instrument comprising:
a collecting section configured to collect air between a mattress and a person lying on the mattress;
a first flow path that is connected to the collecting section;
a first temperature-humidity sensor that is connected to the first flow path, the first temperature-humidity sensor being configured to measure a temperature and a humidity of the air collected in the collecting section;
a second flow path that is connected to the first temperature-humidity sensor; and
a first air blowing apparatus configured to send the air measured by the first temperature-humidity sensor to the collecting section.

2. The temperature-humidity measurement instrument according to claim 1, wherein the first air blowing apparatus is provided between the first temperature-humidity sensor and the second flow path.

3. The temperature-humidity measurement instrument according to claim 1, wherein the first temperature-humidity sensor is provided outside the mattress.

4. The temperature-humidity measurement instrument according to claim 1, further comprising:
a chamber in which the air sent to the first temperature-humidity sensor is stored, wherein
the first temperature-humidity sensor is provided inside the chamber.

5. The temperature-humidity measurement instrument according to claim 1, wherein the collecting section has a bag shape.

6. The temperature-humidity measurement instrument according to claim 1, wherein the collecting section has a bag shape and comprises an upper film, an intermediate film, and a lower film.

7. The temperature-humidity measurement instrument according to claim 1, wherein the first flow path and the second flow path each comprise polyurethane, polyethylene, rubber, vinyl chloride, or silicone.

8. The temperature-humidity measurement instrument according to claim 5, wherein the first flow path and the second flow path each comprise a polyurethane foam provided to an outer peripheral section thereof.

9. The temperature-humidity measurement instrument according to claim 4, wherein
the chamber comprises a first chamber and a second chamber; and
the first temperature-humidity sensor is provided inside the first chamber.

10. The temperature-humidity measurement instrument according to claim 9, wherein the second chamber is provided to a lower part inside the chamber.

11. The temperature-humidity measurement instrument according to claim 9, wherein the second chamber is provided between the first temperature-humidity sensor and the collecting section.

12. The temperature-humidity measurement instrument according to claim 1, wherein at least any of the collecting section, the first flow path, and the second flow path comprises a flexible substance.

13. The temperature-humidity measurement instrument according to claim 1, wherein the collecting section, the first flow path, and the second flow path comprise a flexible substance.

14. The temperature-humidity measurement instrument according to claim 1, further comprising:
a second temperature-humidity sensor configured to measure a temperature and a humidity of indoor air; and
a second air blowing apparatus configured to send the indoor air to the mattress in accordance with the temperature and the humidity measured by the first temperature-humidity sensor and the second temperature-humidity sensor.
